(19) United States
(12) Patent Application Publication
(10) Pub. No.: US 2023/0153495 A1
(43) Pub. Date: May 18, 2023

(54) SYSTEM AND METHOD FOR A MULTIDIMENSIONAL ENVIRONMENTAL MESH

(71) Applicant: True Elements, Inc., Naples, FL (US)

(72) Inventors: William C. LOUISELL, III, Mt. Pleasant, SC (US); David BANKSTON, Naples, FL (US)

(21) Appl. No.: 17/988,574

(22) Filed: Nov. 16, 2022

Related U.S. Application Data
(60) Provisional application No. 63/280,307, filed on Nov. 17, 2021.

(51) Int. Cl. G06F 30/28

(52) U.S. Cl. CPC G06F 30/28

(57) ABSTRACT

Systems, methods, and computer-readable media for modeling how water, contaminants, and other materials impact neighboring geographic areas. A system can receive data (such as topology data and hydrological data) associated with a geographic area and generate a three dimensional map of the geographic area. The three dimensional map can have cells, each cell cells corresponding to a sub-portion of the geographic area, and each cell having metadata. The system can further modify the three dimensional map to include relationships between the plurality of cells, the relationships based on interactions between the cells, resulting in a digital mesh. When the system receives a request for predicted water quality at a location within the geographic area, the system can model the environmental conditions for the geographic area using the digital mesh, the metadata, and sensor data, resulting in predicted environmental conditions.

### CROSS-REFERENCE

This application claims priority to U.S. provisional patent application No. 63/280,307, filed Nov. 17, 2021, the contents of which are incorporated herein by reference in their entirety.

### BACKGROUND

### 1. Technical Field

The present disclosure relates to a multidimensional environmental mesh, and more specifically to creating a model for how water, contaminants, and other materials impact neighboring geographic areas.

### 2. Introduction

Environmental data, specifically data related to water quality, involves the integration of many types of data including meteorology, hydrology, hydrography, land use, land cover, soil characteristics, and ground water systems (such as aquifers and sub-terranean flow nets). Further, environmental characteristics, such as air quality or water quality, are related to sources both point and non-point, including discharges into the air, onto the terrain surface, directly into elements of the riverine system, and directly into the ground. Because of the many different types of data, the many different ways in which water and other materials can be introduced into the system, how the conditions of a given geographic area impact neighboring geographic areas, and the constant updating of the environmental data, previous attempts to model the quality of a given area's water or air have provided incomplete forecasts.

### BRIEF DESCRIPTION OF THE DRAWINGS

FIG. 1A illustrates an example of different types of data associated with a given geographic area;

FIG. 1B illustrates the different layers of data spatially aligned;

FIG. 1C illustrates the spatially aligned layers with lateral connections for preparing changes over time;

FIG. 1D illustrates the spatially aligned layers at different times;

FIG. 2 illustrates examples of how a geographic area can be divided;

FIG. 3 illustrates an example process for acquiring data associated with a geographic area and filling in missing data;

FIG. 4 illustrates examples of how to communicate water quality of a geographic area to a system user;

FIG. 5 illustrates subdivisions of a given geographic area and the relationships between those subdivisions;

FIG. 6 illustrates an example multi-dimensional spatial map corresponding to a geographic area;

FIG. 7 illustrates an example of data transfers between cells;

FIG. 8 illustrates an example method embodiment; and

FIG. 9 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

In order to build a comprehensive environmental quality prediction system for a given geographic area, multiple types of data need to be combined in a way which creates a spatially multi-dimensional model of the geographic area, where the interactions between sub-portions (cells) of that model interact with one another based on relationships which are defined by the data used to build the model. If, for example, the system were modeling water quality of a given geographic area which is 10×10 kilometers, for a total of 100 square kilometers, and includes an average of half a kilometer of air above the surface and half a kilometer below the surface as part of the map, for a spatial multi-dimensional map which has an area of 100 cubic kilometers. The spatial multi-dimensional map is three dimensional, extending in the height, width, and depth (aka, “X, Y, Z”) dimensions. The data used to create this spatial multi-dimensional map can include, for example, topographical data associated with the geographic area, subterranean maps, atmospheric maps, etc.

That spatial multi-dimensional map can be further sub-divided, such that each sub-portion (“cells”) of the multi-dimensional map has customized properties particular to the corresponding sub-portion of the geographic area. The shape of the cells can be cubes, “bricks” (comparable to the appearance of a Rubik's cube), or any other three dimensional space, and the cells may or may not be equally sized within the overall spatial multi-dimensional map (e.g., a naturally bounded irregular end shape, a man-defined linear shape, and/or a gridded shape). The customized properties of the cells can be determined from additional layers of data associated with the geographic area. For example, the data used to create the spatial multi-dimensional map may include soil data for the geographic area, such that the metadata associated with a given cell of the multi-dimensional map can include soil data for the corresponding sub-portion of the geographic area. In addition to soil data, other types of data which can be included for a given cell can include the water table height, the porosity of the soil, known contaminants in a given area, aquifer and groundwater properties for that region, topology, man-made and natural hydrographic systems, jurisdictional/man-made boundaries, and/or weather data.

From this same data, the system creates relationships between each cell and each of its neighbors. Assuming the cells are cubes, this means that any cell not located at the edge of the spatial map would have nine relationships to cells located above it (including the cells located diagonally from the cell in question), eight relationships to cells located on the same level, and nine relationships to cells located below it, for a total of twenty six relationships. If the shape of the sub-portion is not cubic or rectangular in nature, the number of relationships for a given cell can vary. Each of the relationships define how a given cell interacts with a neighboring cell given certain circumstances. Such numbers and relationships are exemplary only. For example, in other configurations relationships may not extend diagonally between cells. Likewise, some categories of relationships may only extend vertically (e.g., rain falling), though the subsequent relationships may extend both horizontally and vertically (e.g., once the rain has fallen, it may effect neighboring cells through runoff, as well as aquifers, soil, and other below-the-surface features).

The cells, their metadata and relationships together form an environmental model for the geographic area—however the model is not static. The model can adapt and be modified depending on new information received from databases, sensors, and/or other information sources. Consider the following examples. If a given cell is identified as receiving, due to a relationship with at least one neighboring cell, a large amount of water from a storm, the metadata for that cell associated with water table height will likely change. In addition, a certain amount of water will then be flowing from that cell to neighboring cells which are hydrologically downstream from the given cell. As another example, if a weather report identifies sunny weather in one portion of the geographic area, and cloudy weather in another, the cells in the sunny weather portion may have their water levels lowered more than the cells of the cloudy weather due to the difference in evaporation.

Because the system is constantly receiving new and updated environmental data, the model is constantly updating and adapting. Such updates are not limited to the metadata stored in particular cells, but can also be directed to geographical boundaries associated with particular cells, as well as the relationships between cells. For example, consider a model for a geographic area containing a lake, where some cells within the model emulate the land surrounding the lake and some cells emulate the lake water itself. Cells forming the border between the land and water may have an irregular, non-cubic shape, allowing for clear differentiation between model's land cells and water cells. However, that border may shift due to drought, rain, water usage, weather, and/or other factors. Accordingly, the shape of the cells may change based on the data being received and processed by model, as can the metadata associated with the individual cells, the relationships between the cells, and/or any other aspect of the model. Because of the constant updating and adapting of the model, it can also be referred to as a “mesh” of adapting relationships and characteristics.

With the model constructed, inputs can be provided to the model in the form of known current conditions and predicted future conditions, such as weather. A user of the model can then, for a single cell or multiple cells, request a prediction for conditions regarding water quality, water quantity, contaminants, and/or other factors within the geographic area associated with one or more cells. This prediction can require the system to relate computational outputs of the model to a range of spatial reference systems that meet the contextual needs of users, and which provides a meaningful frame of reference to the end-user. For instance, in some cases the output associated with a given request may be most appropriately expressed in hydrologic, hydrographic, topological, and/or soil system terms (context), and then may be expressed in terms of man-defined boundary systems such as socio-economically related regions, states, counties, cities, zip codes, and/or property boundaries (spatial frame of reference). In order to better define the spatial frame of reference, such boundaries or areas can be expressed in GPS terms or in terms of the applicable public land surveying system. If the requested geographic area contains two or more cells (the smallest geographic portions within the model), the user can then “zoom in” on one or more of the sub-portions within the requested geographic area.

As an example, in response to a simple question about the water quality for a city, the system may report that the water quality for San Francisco has a score of 75 out of 100. In some instances such information may be sufficient for the user's needs. However, in other circumstances, the user may wonder what the water quality is near the beach, in the downtown metro area, or in the mountains. In order to better identify relationships over different geographic areas, the system can identify multiple locations with equal values of a given substance, quality, or characteristic, and create a topological contour line with respect to that element. If, for example, the system had data identifying multiple areas of San Francisco that all had water quality scores of 75, multiple areas that had water quality scores of 80, and multiple areas that had water quality scores of 70, the system can connect the areas that have common water quality scores to form contour lines, with the result being a map showing common patterns between the different areas, or how the water quality shifts over the region, allowing (for example) city engineers to determine why water quality changes between areas, and providing a more advanced approach to managing water supply quality and quantity than previously available.

Because the data being input to the model is often viewed in isolation, the system executes a range of computational methods (such as soft computing methods, including (but not limited to) fuzzy logic, genetic algorithms, artificial neural networks, machine learning, and expert systems) particularly suited to the nature of water quality & quantity data, where data is often incomplete, low in density, and infrequent in generation. For an example hydrological model, the resulting digital mesh can compute, for any point along a continuous spectrum, estimates for water quality & quantity data in a given geographic area. This ability to predict environmental quality and quantity data for other types of models (such as an air quality model) is likewise also viable as disclosed herein.

Put another way, systems configured as disclosed herein can organize, spatially normalize, and temporally align disparate data bases. If, for example, one knows a level of contamination at points A and B, the system can estimate the level of contamination in the middle using a combination of A.I. (Artificial Intelligence), soft computing, and imputation embedded within meteorologic/hydrologic/hydrographic/topologic/soil structure/groundwater data to connect sensor data, model, and estimate environmental values across entire geographic regions (e.g., the seven state Colorado River basin). The user can specify a specific location between two or more sensors, and the system can return an estimate for the respective environmental condition at that location by identifying which cell within the model/mesh corresponds to the location and computing future conditions using current conditions, predicted conditions, and the predefined relationships between cells.

For example, if sensors were deployed within a city's water system at known locations to detect for a given chemical, the amounts detected by those sensors can be combined with additional data (such as geographic, elevation, weather, hydrological, and/or infrastructure data), input into an AI engine, and modified using fuzzy logic coefficients, termed “modification coefficients,” (not necessarily in that order) to estimate the level of that chemical at specific locations other than the sensor locations, such as a location between the sensors. Likewise, if sensors at multiple locations identify those water-borne contaminants that (due to their volatility) transition to air-borne contaminants, and one wanted to estimate the air quality with respect to those particular contaminants at a location between sensors, a system configured as described herein can collect data from those sensor locations, combine it with weather data, input the aggregated data into an AI engine, modify the output using fuzzy logic (again, not necessarily in that order), and obtain an estimate for the air quality influence of those contaminants that do make the transition from a water-borne state to an airborne state at that location. In this manner, the system can allow users to view environmental data at any scale, with the ability to “zoom in” or “zoom out” on locations which are distinct from the sensor locations and view estimates for those specific locations based on the known data, the AI engines and soft computing systems.

The resulting estimate is an output of the AI, soft computing, and imputation engines optimized for environmental quality & quantity respecting interaction between human system (land use, agriculture practices, stormwater systems, industry sectors, water treatment processes, and wastewater treatment discharges) and earth systems (meteorologic, hydrologic, hydrographic, topologic, soil structure, and groundwater systems). The output of the digital mesh can also provide a localized multi-layer view vertically oriented from the atmosphere down to underground water systems. For example, if a user selects to view a given geographic area, the system can output a view of the different vertical layers of that geographic area. Moreover, the user can also adjust the level of granularity of the specific location being evaluated, such that the area associated with a request can vary based on user need or preference. For example, if a given geographic area covered an area extending from the ocean to the mountains, the digital mesh can predict the entire water journey of a raindrop to the sea. A user of the system can view the entirety of the geographic area, or can select a specific portion of that geographic area and the system can “zoom in” on that area by providing the data associated with the corresponding cells of that sub-portion.

Because sensors can be associated with both public and private data services for a specific geographic area (such as a watershed, a valley having common pollution issues, an area surrounding a farm or other location where herbicides/pesticides are being used or deployed), the data collected from those sensors can require normalization between sensor report data formats, datum references, and units of measure. In environmental quality & quantity data normalization, spatial and temporal tagging is particularly complex and necessary to support down-process data operations. Complexity is driven by variables that are not associated with the normal practices of spatial data mensuration. For example, in water quality and quantity problems, the difficulty goes beyond simply resolving different coordinate systems such as WGS-84 (World Geodetic System 1984 ensemble), UTM (Universal Transverse Mercator), and GPS (Global Positioning System). Water, its direction and velocity of flow, are driven by interacting natural and man-made systems—topology of the natural world, the elevation overlay of the built environment, and the soil properties specific to water. To resolve this complexity, system includes within the digital mesh relationships, light weight, fast, agent-level applications. These agent-level applications, built into the relationships between cells, can intercept data at the point and time of origin, normalize it, and transform it into a metadata tag that follows each flow element as it moves throughout the cell matrix. For example, a metadata tag associated with a cubic foot of runoff can stay with the water as it moves from cell to cell throughout the digital mesh.

One challenge arising from the constant updating and adapting is temporally synchronizing the model, such that all of the changes to the cells are occurring in a spatially and temporally synchronized manner. To account for this challenge, the digital mesh acts as a time delay manager. At each cell-to-cell transition for a flow element, and for each parameter in the cell-to-cell interchange table (a list of the cell-to-cell relationships within the digital mesh), a time delay factor is called, used, and discarded. For example, the time associated with overland and riverine flow can be computed based on the local terrain roughness, slope, and length of run. Time from point of origin is passed and updated in each cell, creating the necessary element of prediction of time of arrival at the next point of interest (e.g., a drinking water plant intake pipe or a recreational beach, etc.). The digital mesh can update cells and relationships between cells based on the estimated time of arrival of a given element (e.g., water), allowing the system to only process cell-to-cell transmissions of data based on when changes should be happening. This can be coupled with the data from real-time sensors which can verify the predicted changes.

Information associated with a given layer of data can result in updates to other layers of data, as well updates or changes to cells associated with neighboring geographic areas. For example, when rain is falling in a cell's geographic boundaries (which could be associated with a weather forecast layer), the falling rain can impact the hydrological zones and water flow layer. Based on the topology and soil properties layer, the hydrological zones and water flow layer can impact the aquifer systems and groundwater sources layer. Such changes between layers of a common geographic area can be considered “vertical” transfers. In addition, because water flows, activity within a geographic area will impact surrounding areas. For example, water located within a geographic area may flow into a neighboring geographic area which is downstream via a river or stream. Such changes between neighboring cells based on geography can be considered “horizontal” transfers.

Both vertical and horizontal transfers can take into account a quantity of an element being moved (e.g., the quantity of an element, such as air or water, moving between layers, or between neighboring cells) and the quality of that element (e.g., specific composition, contaminants, etc.). In addition, when transfers do occur (both between layers and between neighboring cells), there can be losses as part of the transfer. For example, water travelling between neighboring cells may evaporate, resulting in a reduced quantity of water entering the neighboring cell than was present in the first cell. Likewise, the quality of elements may be effected during a transfer. For example, the amount of contaminants moving between layers, or to neighboring geographic cells, may be reduced based on the types of contaminants (e.g., some may be heavier than others, and less likely to travel), based on the porosity of the soil, based on the buoyancy and/or volatility of the contaminants (e.g., oils may float on the surface of the water, and therefore be more likely to transfer, compared to heavier contaminants), etc.

As an example, real-time sensor data may be obtained from disparate public and/or private databases, as well as IoT (Internet of Things) devices (such as water quality & quantity sensors, water physical property sensors, smart water management systems, etc.). These sensors, deployed at various locations within the geographic area are linked to the digital mesh as a means to provide a normalization and establish a pedigree of environmental quality and quantity descriptive data by point and time origin. Data called from a particular sensor, regardless of point of storage to point of use, can retain spatial and temporal properties throughout the data life cycle.

Further, the IoT data may or may not provide consistent data, such that the system may need to adjust, “fill in,” or otherwise compensate for missing data points using soft computing methods such as Fuzzy Sets Theory. Such “filling in” of the data can go beyond simply averaging neighboring data, and can include use of information about similar geographic regions, similar elemental properties, and/or similar land use, while recognizing seasonal variance in contaminants constituency, and adapting to differences in topology, population density, landscape type, etc., to predict what the missing data is likely to be. In some configurations, systems configured as disclosed herein can implement a feedback system, such that the mechanisms used to make predictions of missing data are periodically updated (e.g., machine learning), resulting in future iterations of the normalized data having refined predictions because the factors used to make the predictions have been modified. Such modifications to the predictive logic can, for example, can be identified using simple regressions and/or higher level deep learning mechanisms for adjusting which factors most heavily influence the predicted missing data.

Regarding the granularity available to the user, the system can use any reference system supported by the digital mesh such as latitude and longitude (though others can also be defined), over a geographic map of the geographic area for which the multi-dimensional map and digital mesh correspond. The user can use the multi-dimensional map to identify a specific quadrant, cell, or sub-portion which the user wishes to view predictions, current data, and/or spatially other data generated within the digital mesh for that cell. In cases where there is no sensor data within a selected region, the estimations/predictions generated by the digital mesh will be presented to the user. In some configurations, the system can be configured to continue using grid granularity to a minimum area, which can vary from system to system according to need and the particular environment/environmental data being analyzed. For example, in some configurations the system may have a minimum area of a square kilometer corresponding to a single cell within the multi-dimensional map (and by extension, the digital mesh), whereas in other configurations the system may have a minimum area defined by the user. As stated above, the minimum area can be other shapes, such as a circle, sphere, rectangle, cube, etc. While in some configurations, the minimum area available to a user is predefined, in other configurations the minimum area can be based on the geography, topography, climate type, density of sensors, etc., and the system can vary the ability to “zoom in” based on those factors. For example, the system may be configured such that if a user were to attempt to “zoom in”/view a higher level of detail for a region where there are many sensors, the system allows for a smaller minimum area than if the user were to “zoom in” on an area that has few sensors. In other words, the system can vary the amount of “zoom” available based on the amount of data contained within a given area.

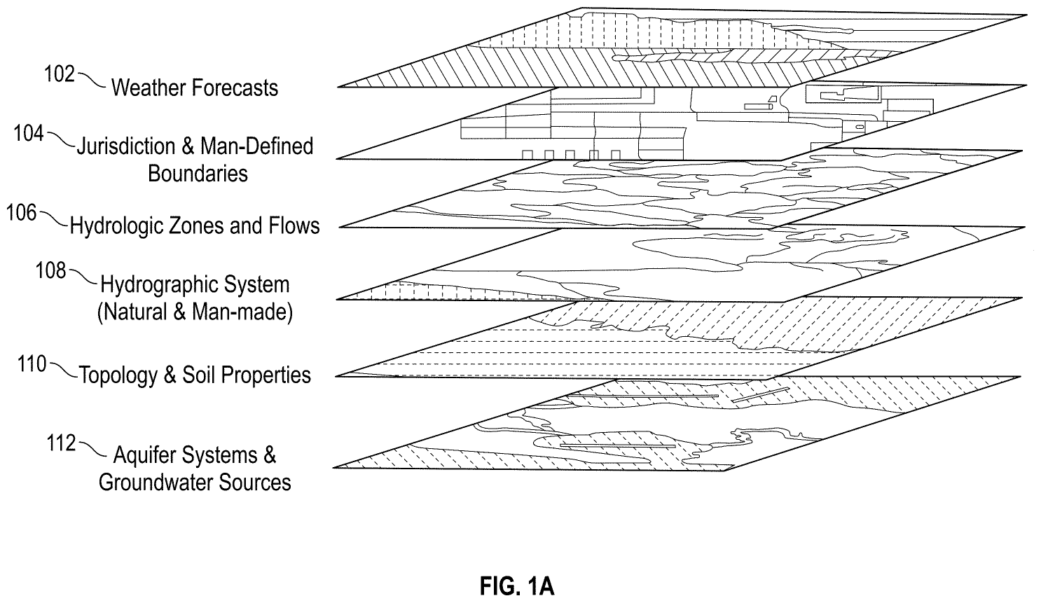

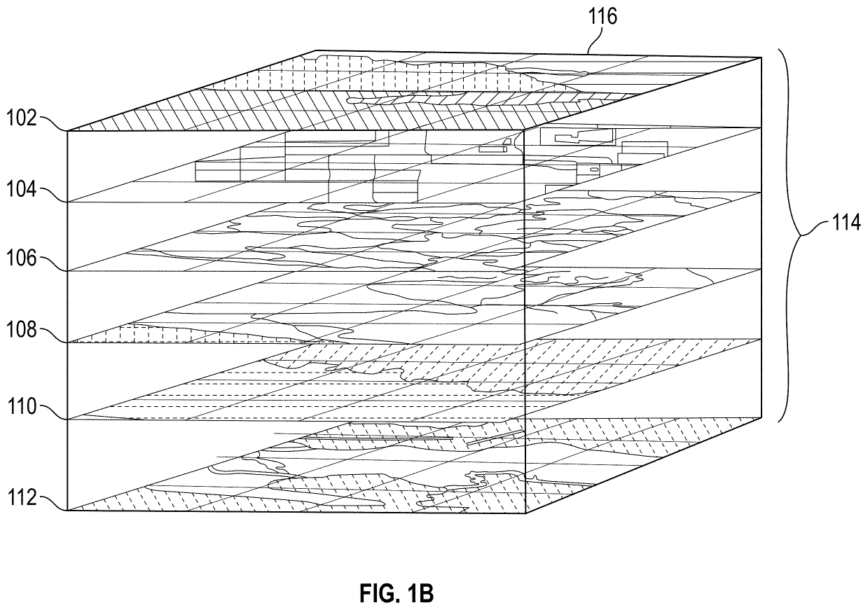

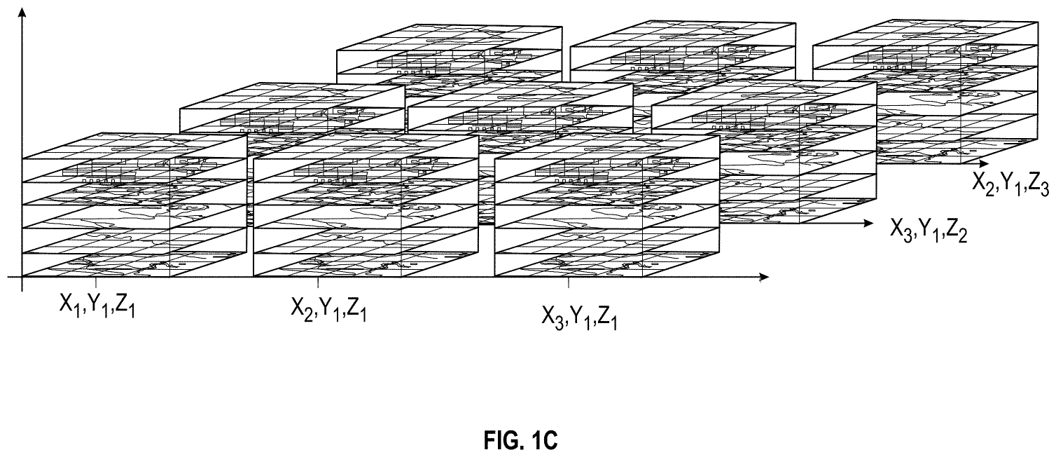

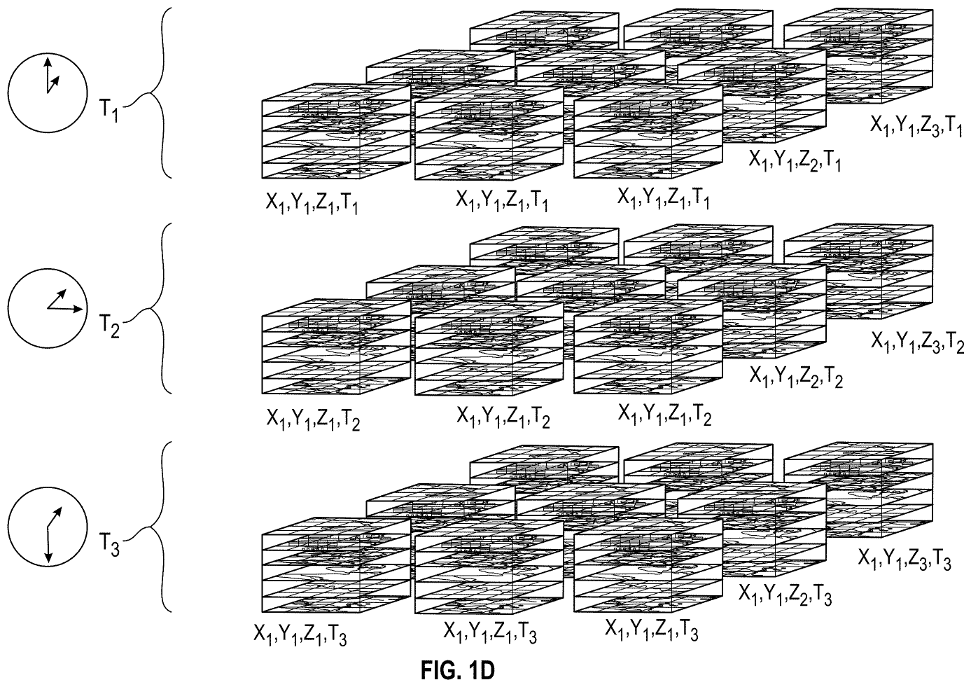

FIG. 1A illustrates an example of different types of data associated with a given geographic area. As discussed above, the system is built using multiple layers of data that represent the elements of the man-made and natural environments. As illustrated, exemplary data that can be used to define/build the multi-dimensional spatial map and the relationships between cells can include weather forecasts 102, jurisdiction & man-defined boundaries 104 (such as states, provinces, city boundaries, zip codes, demographic data, etc.), hydrologic zones and flows 106, hydrographic systems 108 (both natural and man-made), topological and soil properties 110, and aquifer & groundwater sources 112. In other configurations, additional data may be used, or various types of the data may be excluded, as required for a specific use or need.

FIG. 1B illustrates the different layers 102-112 of data spatially aligned into a map forming a grid 114, 116 (e.g., spatially aligned), with layer-specific data capable of exchanging data with other layers through vertical interaction. In this example, there exists layer-to-layer alignment and synchronicity using the connections (relationships) between cells and layers, and through the use of time constants.

FIG. 1C illustrates the spatially aligned layers with lateral connections connecting the layers of data associated with a given geographic area (illustrated, for example, in FIGS. 1A and 1B) and the neighbors of that geographic area. As illustrated, there can be multi-dimensional arrays which will model how a given cell will be modified over time based on the relationships and connections between cells and between neighboring areas.

FIG. 1D illustrates the spatially aligned layers at different times. In this illustration, each respective row of 3D models represents a 15 minute shift in time (as illustrated by the example clocks within the figure), and the time values associated with each geographic area also changes (e.g., T₁, T₂, T₃). In other configurations, the times between iterations can vary. For example, in some configurations the model can update every thirty minutes, every one hour, every twenty-four hours, etc. As the system receives temporal updates, the data associated with each cell/layer/geographic area, etc. can be saved within the system and associated with a specific time, such that the system can use that data to improve upon predictive abilities for future iterations.

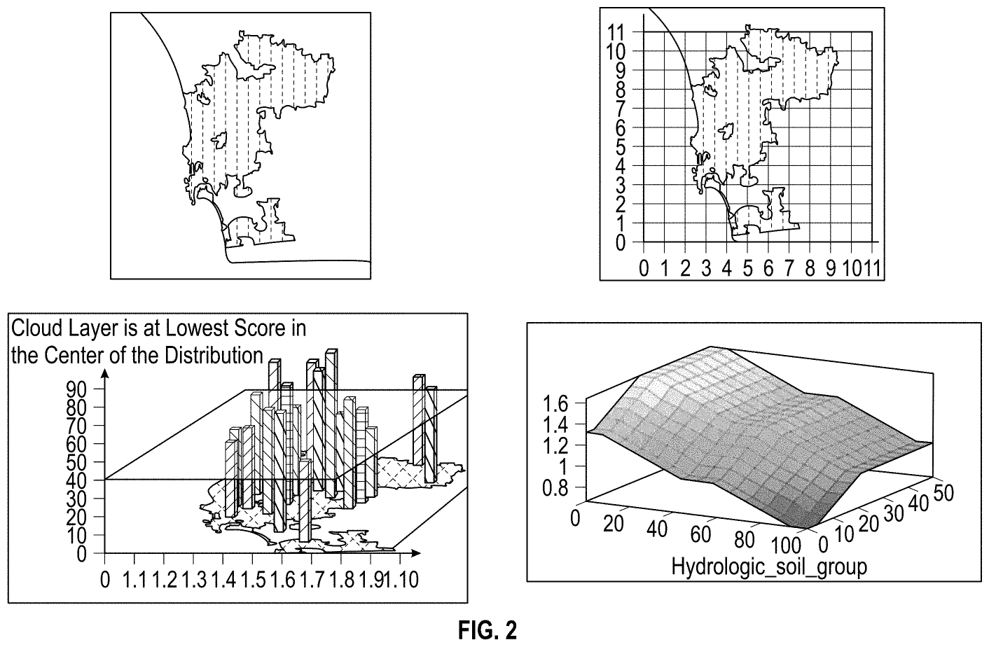

FIG. 2 illustrates an example of the horizontal relationships between neighboring digital mesh ‘cells’ within a geographic area 202. In this example, a geographic area 202 has been predefined, with specific known polluters 206 identified on the map by various bars, along with respective levels of pollutants at the respective polluters (illustrated by the height of the polluter bars). Also illustrated in FIG. 2 is a grid 204, overlaid on top of the map, illustrating the system's capacity for greater granularity, as well as the ability to refer to specific quadrants of the map. Lastly, the use of soft computing (Fuzzy Sets Theory and/or Genetic Algorithms) to take point values and create a value mesh 208 that reveals contour lines in the distribution of a parameter of interest. In this case, the value mesh 208 reveals how a selected parameter (e.g., a contaminant being released by the pollution) moves between cells within the geographic area 202.

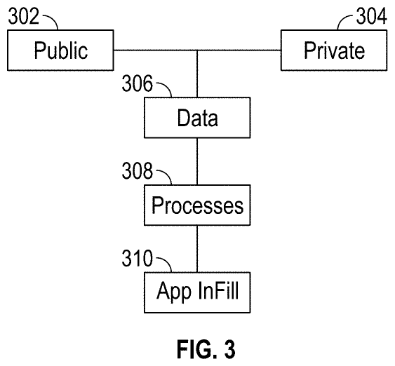

FIG. 3 illustrates a first example of collecting and processing environmental data. In this example, sensor data is obtained from both public 302 and private 304 resources, such as IoT devices and/or databases. The sensor data can then be aggregated 306, processed 308, and any gaps or holes in the data can be filled via an “App InFill” program 310. In some configurations, this filling in of the data can occur using an AI engine, machine learning, known geography/topography/hydrological data, and soft computing (Fuzzy Sets Theory and/or Genetic Algorithms) to blend data sources and provide infill where required.

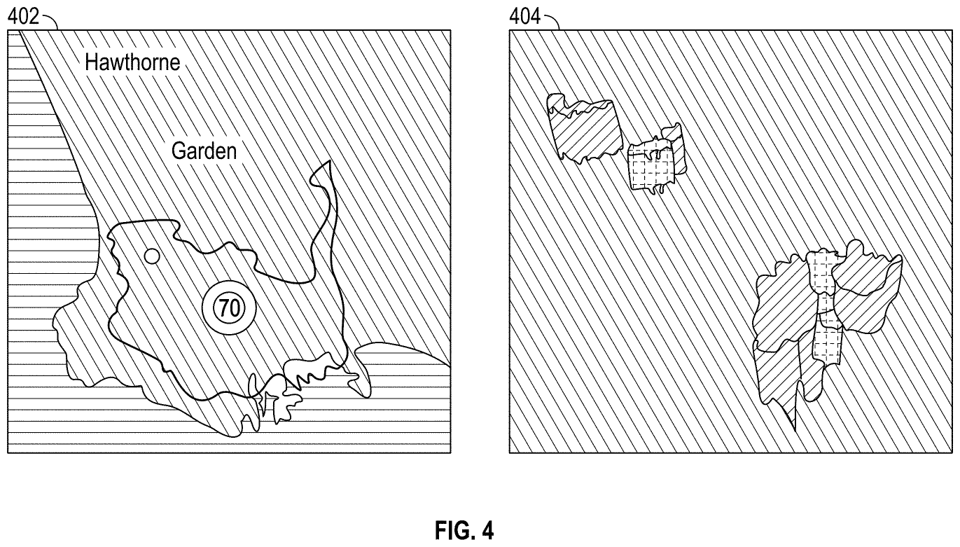

FIG. 4 a range of user viewing options. The first example 402 illustrates the presentation of digital mesh enabled computations and point references developed in a hydrologic and hydrographic spatial reference system onto a 2-D zip code-based system in response to user needs. The second example 404 illustrates zones of toxicity in a 3-D view that represents the digital mesh powered computational cells that carry the irregular boundary systems associated with zip codes. In the second example, the presence of spatially differentiated contours identified in the computational engines is made to be evident.

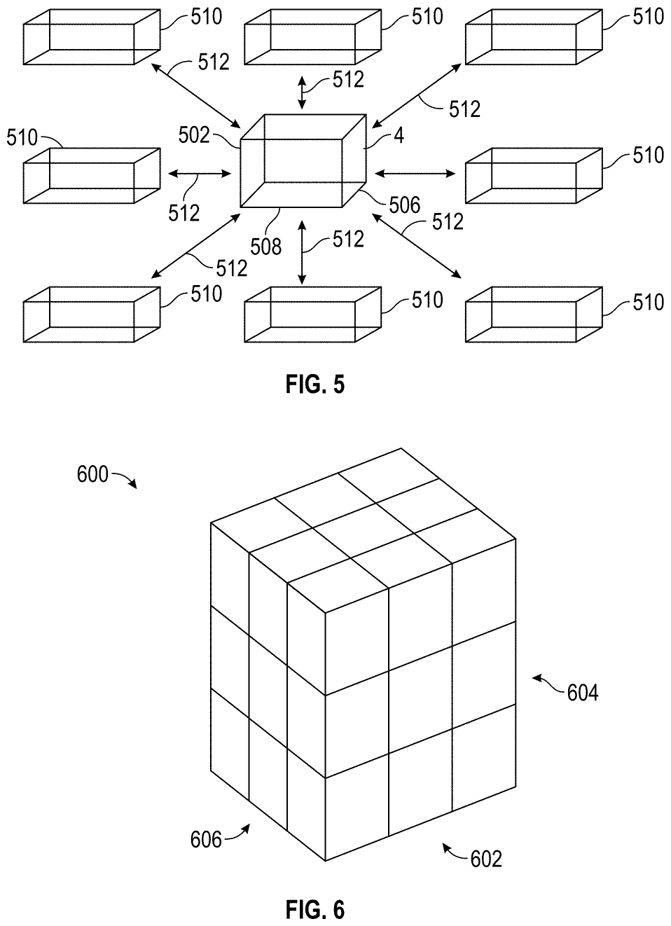

FIG. 5 illustrates subdivisions of a given geographic area and the relationships between those subdivisions. In this example, a geographic area is divided into a multidimensional (3-D) spatial map. Each cell 502, 510 in the geographic area represents a sub-portion of the overall geographic area. While in this example the cells 502, 510 are cubes, in other configurations the cells can have different geometric properties, forming different shapes as required computationally or as required to best match the underlying formations (topological, man-made, or otherwise). In this example, each cell can have a width 508, depth 506, and height 504. In configurations where the cells are cubic, these dimensions 504, 506, 508 can be equal to one another. In other where the cells are non-cubic the dimensions 504, 506, 508 can vary from one another.

As described above, each cell 502, 510 can have various aspects of metadata associated with it. This data can identify particular features, such as soil type, water level, slope, land use (e.g., farming, suburban, or city), and/or other aspects of topology. This data can also include aspects of current weather, aspects regarding elements traversing the geographic area. These features for a given cell 502 can be updated based on sensor data and/or the relationships 512 with neighboring cells 510 within the digital mesh. The relationships 512 themselves can also be updated based on the additional data collected from sensors, the data being passed from one cell to another, etc.

FIG. 6 illustrates an example multi-dimensional spatial map 600 of the geographic area. In this example, the cells 502, 510 of FIG. 5 are illustrated with their respective borders touching, such that the various cells form a contiguous spatial model emulating the geographic area. As illustrated, the height 604, width 606, and depth 602 are equal, but this can vary according to need or configuration. While the illustrated multi-dimensional spatial map 600 illustrates a cubic space of 3×3×3 cells (for a total of 27 cells), in other configurations the number of cells in any layer can vary as needed. Indeed, within a given model there may be portions where certain portions of the multi-dimensional spatial map 600 contain an additional layer. In other words, the multi-dimensional spatial map 600 does not need to be equal and could, for example, have a first portion which is made of a 4×4×8 set of cells, a second portion which is 4×5×8 cells, and a third portion which is 4×8×8 cells, with all three portions being interconnected.

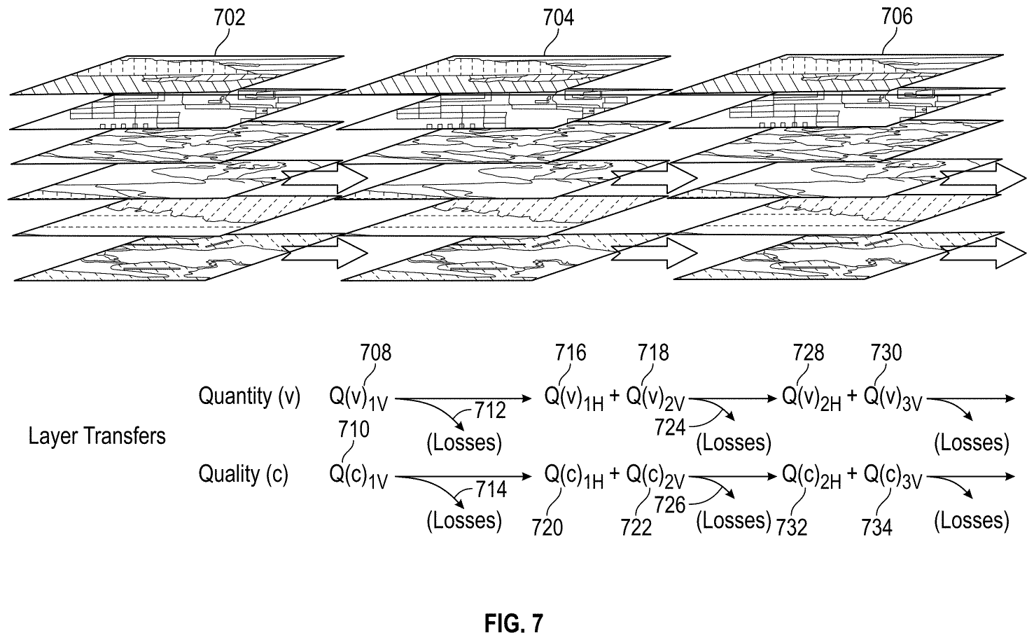

FIG. 7 illustrates an example of data transfers between cells. In this example, there are neighboring sets of cells 702, 704, 706, each of which have layers of data. In addition, there is a transfer of an element (such as water, air, etc.) from cell 702 to cell 704, and again from cell 704 to 706. Over time, the elements will move/transfer between layers and cells, and the exemplary layer transfers at the bottom of FIG. illustrate those transfers. For example, beginning with cell 702, there is a quantity Q(v)_{1V} 708 of the element, as well as a quality Q(c)_{1V} 710 associated with the element, in cell 702. As the element moves from cell 702 to cell 704, there is a loss in both quantity 712 and quality 714. Some of those losses may remain in cell 702, whereas others may disappear (such as evaporation, oxidation, rust, or other deterioration mechanisms). The second cell (cell 704) then has a quantity equal to the initial quantity Q(v)_{2V} 718 for cell 704 plus the quantity transferred Q(v)_{1H} 716 from the first cell (cell 702). The second cell 704 also has a quality based on the initial quality Q(c)_{2V} 722 in the second cell 704 plus the quality transferred Q(c)_{1H} 720. As the element (e.g., water) continues to flow to the third cell 706 from the second cell 704, losses 724, 726 again occur, with the result being that the third cell 706 has a has a quantity equal to the initial quantity Q(v)_{3V} 730 for cell 706 plus the quantity transferred Q(v)_{2H} 728 from the second cell (cell 704). The third cell 706 also has a quality based on the initial quality Q(c)_{3V} 730 in the third cell 706 plus the quality transferred Q(c)_{2H} 734. Please note that within the illustrated example, the H and V subscripts refer to horizontal transfers (e.g., between cells) and vertical transfers (e.g., between layers). However, the specific layers resulting in horizontal transfers can vary according to configuration.

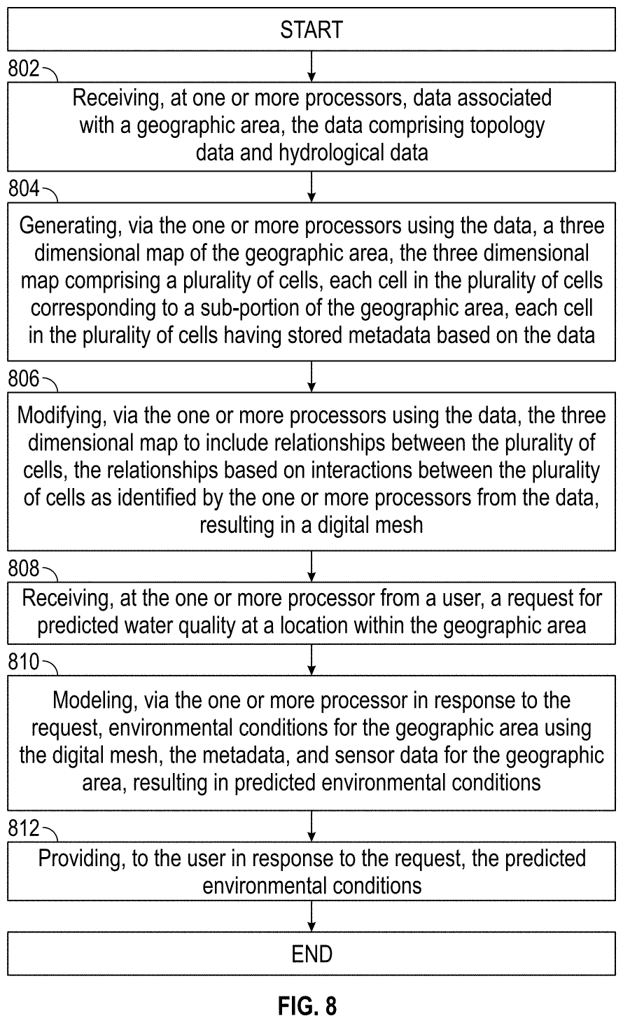

FIG. 8 illustrates an example method embodiment. As illustrated, the method can include: receiving, at one or more processors, data associated with a geographic area, the data comprising topology data and hydrological data (802); generating, via the one or more processors using the data, a three dimensional map of the geographic area, the three dimensional map comprising a plurality of cells, each cell in the plurality of cells corresponding to a sub-portion of the geographic area, each cell in the plurality of cells having stored metadata based on the data (804); modifying, via the one or more processors using the data, the three dimensional map to include relationships between the plurality of cells, the relationships based on interactions between the plurality of cells as identified by the one or more processors from the data, resulting in a digital mesh (806); receiving, at the one or more processor from a user, a request for predicted water quality at a location within the geographic area (808); modeling, via the one or more processor in response to the request, environmental conditions for the geographic area using the digital mesh, the metadata, and sensor data for the geographic area, resulting in predicted environmental conditions (810); and providing, to the user in response to the request, the predicted environmental conditions (812).

Exemplary environmental conditions can include water quality and/or air quality.

In some configurations, the modeling can predict transmission of environmental matter within the geographic area, the transmission modeled by modifying the metadata of each cell based on the relationships and the sensor data. In such configurations, examples of the environmental matter can include water and/or groundwater contaminants.

In some configurations, the illustrated method can further include, prior to the generating of the three dimensional map, normalizing the data.

In some configurations the data can identify levels of contaminants, pollutants, and/or toxins within a water supply, air, or soil.

In some configurations, the illustrated method can further include: retrieving, from at least one private database, private environmental data from private sensors within the geographic area; and retrieving, from at least one public database, public environmental data from public sensors within the geographic area, wherein the inputs to modeling can further include the private environmental data and the public environmental data.

In some configurations, the geographic area can be contiguous, whereas in other configurations the geographic area may be non-contiguous.

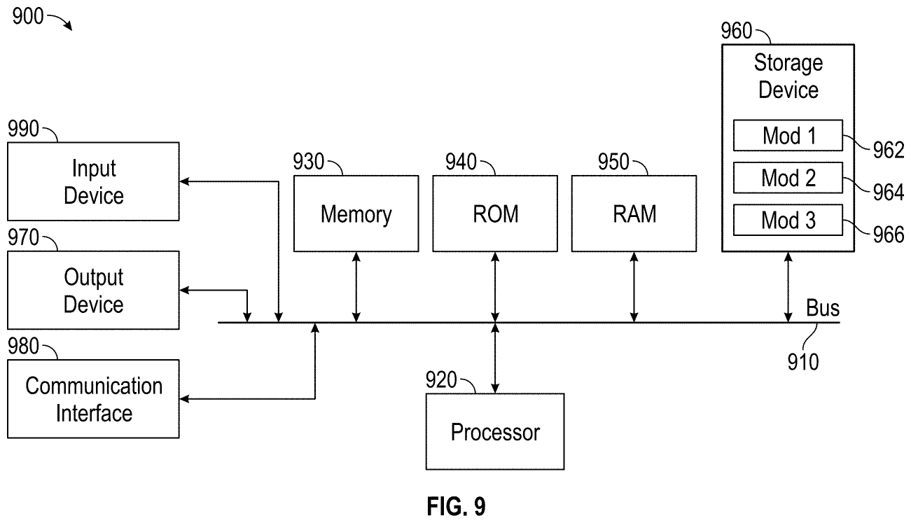

FIG. 9 illustrates an example computer system 900, including a processing unit (CPU or processor) 920 and a system bus 910 that couples various system components including the system memory 930 such as read-only memory (ROM) 940 and random access memory (RAM) 950 to the processor 920. The system 900 can include a cache of high-speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Further aspects of the present disclosure are provided by the subject matter of the following clauses.

Claims Listing

A method comprising: receiving, at one or more processors, data associated with a geographic area, the data comprising topology data and hydrological data; generating, via the one or more processors using the data, a three dimensional map of the geographic area, the three dimensional map comprising a plurality of cells, each cell in the plurality of cells corresponding to a sub-portion of the geographic area, each cell in the plurality of cells having stored metadata based on the data; modifying, via the one or more processors using the data, the three dimensional map to include relationships between the plurality of cells, the relationships based on interactions between the plurality of cells as identified by the one or more processors from the data, resulting in a digital mesh; receiving, at the one or more processor from a user, a request for predicted water quality at a location within the geographic area; modeling, via the one or more processor in response to the request, environmental conditions for the geographic area using the digital mesh, the metadata, and sensor data for the geographic area, resulting in predicted environmental conditions; and providing, to the user in response to the request, the predicted environmental conditions.

The method of any preceding clause, wherein the environmental conditions comprise water quality.

The method of any preceding clause, wherein the environmental conditions comprise air quality.

The method of any preceding clause, wherein the modeling predicts transmission of environmental matter within the geographic area, the transmission modeled by modifying the metadata of each cell based on the relationships and the sensor data.

The method of any preceding clause, wherein the environmental matter comprises water.

The method of any preceding clause, wherein the environmental matter comprises groundwater contaminants.

The method of any preceding clause, further comprising: prior to the generating of the three dimensional map, normalizing the data.

A system comprising: one or more processors; and a non-transitory computer-readable storage medium having instructions stored which, when executed by the one or more processors, cause the one or more processors to execute operations comprising: receiving data associated with a geographic area, the data comprising topology data and hydrological data; generating, using the data, a three dimensional map of the geographic area, the three dimensional map comprising a plurality of cells, each cell in the plurality of cells corresponding to a sub-portion of the geographic area, each cell in the plurality of cells having stored metadata based on the data; modifying, using the data, the three dimensional map to include relationships between the plurality of cells, the relationships based on interactions between the plurality of cells as identified by the one or more processors from the data, resulting in a digital mesh; receiving, from a user, a request for predicted water quality at a location within the geographic area; modeling, in response to the request, environmental conditions for the geographic area using the digital mesh, the metadata, and sensor data for the geographic area, resulting in predicted environmental conditions; and providing, to the user in response to the request, the predicted environmental conditions.

The system of any preceding clause, wherein the environmental conditions comprise water quality.

The system of any preceding clause, wherein the environmental conditions comprise air quality.

The system of any preceding clause, wherein the modeling predicts transmission of environmental matter within the geographic area, the transmission modeled by modifying the metadata of each cell based on the relationships and the sensor data.

The system of any preceding clause, wherein the environmental matter comprises water.

The system of any preceding clause, wherein the environmental matter comprises groundwater contaminants.

The system of any preceding clause, the non-transitory computer-readable storage medium having additional instructions stored which, when executed by the one or more processors, cause the one or more processors to perform operations comprising: prior to the generating of the three dimensional map, normalizing the data.

A non-transitory computer-readable storage medium having instructions stored which, when executed by one or more processors, cause the one or more processors to execute operations comprising: receiving data associated with a geographic area, the data comprising topology data and hydrological data; generating, using the data, a three dimensional map of the geographic area, the three dimensional map comprising a plurality of cells, each cell in the plurality of cells corresponding to a sub-portion of the geographic area, each cell in the plurality of cells having stored metadata based on the data; modifying, using the data, the three dimensional map to include relationships between the plurality of cells, the relationships based on interactions between the plurality of cells as identified by the one or more processors from the data, resulting in a digital mesh; receiving, from a user, a request for predicted water quality at a location within the geographic area; modeling, in response to the request, environmental conditions for the geographic area using the digital mesh, the metadata, and sensor data for the geographic area, resulting in predicted environmental conditions; and providing, to the user in response to the request, the predicted environmental conditions.

The non-transitory computer-readable storage medium of any preceding clause, wherein the environmental conditions comprise water quality.

The non-transitory computer-readable storage medium of any preceding clause, wherein the environmental conditions comprise air quality.

The non-transitory computer-readable storage medium of any preceding clause, wherein the modeling predicts transmission of environmental matter within the geographic area, the transmission modeled by modifying the metadata of each cell based on the relationships and the sensor data.

The non-transitory computer-readable storage medium of any preceding clause, wherein the environmental matter comprises water.

The non-transitory computer-readable storage medium of any preceding clause, wherein the environmental matter comprises groundwater contaminants.

We claim:

1. A method comprising:
receiving, at one or more processors, data associated with a geographic area, the data comprising topology data and hydrological data;
generating, via the one or more processors using the data, a three dimensional map of the geographic area, the three dimensional map comprising a plurality of cells, each cell in the plurality of cells corresponding to a sub-portion of the geographic area, each cell in the plurality of cells having stored metadata based on the data;
modifying, via the one or more processors using the data, the three dimensional map to include relationships between the plurality of cells, the relationships based on interactions between the plurality of cells as identified by the one or more processors from the data, resulting in a digital mesh;
receiving, at the one or more processor from a user, a request for predicted water quality at a location within the geographic area;
modeling, via the one or more processor in response to the request, environmental conditions for the geographic area using the digital mesh, the metadata, and sensor data for the geographic area, resulting in predicted environmental conditions; and
providing, to the user in response to the request, the predicted environmental conditions.

2. The method of claim 1, wherein the environmental conditions comprise water quality.

3. The method of claim 1, wherein the environmental conditions comprise air quality.

4. The method of claim 1, wherein the modeling predicts transmission of environmental matter within the geographic area, the transmission modeled by modifying the metadata of each cell based on the relationships and the sensor data.

5. The method of claim 4, wherein the environmental matter comprises water.

6. The method of claim 4, wherein the environmental matter comprises groundwater contaminants.

7. The method of claim 1, further comprising:
prior to the generating of the three dimensional map, normalizing the data.

8. A system comprising:
one or more processors; and
a non-transitory computer-readable storage medium having instructions stored which, when executed by the one or more processors, cause the one or more processors to execute operations comprising:
receiving data associated with a geographic area, the data comprising topology data and hydrological data;
generating, using the data, a three dimensional map of the geographic area, the three dimensional map comprising a plurality of cells, each cell in the plurality of cells corresponding to a sub-portion of the geographic area, each cell in the plurality of cells having stored metadata based on the data;
modifying, using the data, the three dimensional map to include relationships between the plurality of cells, the relationships based on interactions between the plurality of cells as identified by the one or more processors from the data, resulting in a digital mesh;
receiving, from a user, a request for predicted water quality at a location within the geographic area;
modeling, in response to the request, environmental conditions for the geographic area using the digital mesh, the metadata, and sensor data for the geographic area, resulting in predicted environmental conditions; and
providing, to the user in response to the request, the predicted environmental conditions.

9. The system of claim 8, wherein the environmental conditions comprise water quality.

10. The system of claim 8, wherein the environmental conditions comprise air quality.

11. The system of claim 8, wherein the modeling predicts transmission of environmental matter within the geographic area, the transmission modeled by modifying the metadata of each cell based on the relationships and the sensor data.

12. The system of claim 11, wherein the environmental matter comprises water.

13. The system of claim 11, wherein the environmental matter comprises groundwater contaminants.

14. The system of claim 8, the non-transitory computer-readable storage medium having additional instructions stored which, when executed by the one or more processors, cause the one or more processors to perform operations comprising:
prior to the generating of the three dimensional map, normalizing the data.

15. A non-transitory computer-readable storage medium having instructions stored which, when executed by one or more processors, cause the one or more processors to execute operations comprising:
receiving data associated with a geographic area, the data comprising topology data and hydrological data;
generating, using the data, a three dimensional map of the geographic area, the three dimensional map comprising a plurality of cells, each cell in the plurality of cells corresponding to a sub-portion of the geographic area, each cell in the plurality of cells having stored metadata based on the data;
modifying, using the data, the three dimensional map to include relationships between the plurality of cells, the relationships based on interactions between the plurality of cells as identified by the one or more processors from the data, resulting in a digital mesh;
receiving, from a user, a request for predicted water quality at a location within the geographic area;
modeling, in response to the request, environmental conditions for the geographic area using the digital mesh, the metadata, and sensor data for the geographic area, resulting in predicted environmental conditions; and
providing, to the user in response to the request, the predicted environmental conditions.

16. The non-transitory computer-readable storage medium of claim 15, wherein the environmental conditions comprise water quality.

17. The non-transitory computer-readable storage medium of claim 16, wherein the environmental conditions comprise air quality.

18. The non-transitory computer-readable storage medium of claim 16, wherein the modeling predicts transmission of environmental matter within the geographic area, the transmission modeled by modifying the metadata of each cell based on the relationships and the sensor data.

19. The non-transitory computer-readable storage medium of claim 18, wherein the environmental matter comprises water.

20. The non-transitory computer-readable storage medium of claim 18, wherein the environmental matter comprises groundwater contaminants.
